(19) United States
(12) Patent Application Publication
(10) Pub. No.: US 2015/0287016 A1
(43) Pub. Date: Oct. 8, 2015

(54) SYSTEMS AND METHODS FOR SENDING INFORMATION TO MOBILE DEVICES UTILIZING MOBILE DEVICE IDENTIFIERS

(71) Applicant: USA TECHNOLOGIES, INC., MALVERN, PA (US)

(72) Inventors: CARY M. SAGADY, CHESTER SPRINGS, PA (US); JOSEPH A. SIMPKINS, WEST CHESTER, PA (US); DENIS KOUZNETSOV, POTTSTOWN, PA (US)

(21) Appl. No.: 14/681,294

(22) Filed: Apr. 8, 2015

Related U.S. Application Data
(60) Provisional application No. 61/976,575, filed on Apr. 8, 2014.

(51) Int. Cl. G06Q 20/32; G06Q 20/10; H04W 4/00; G06Q 20/18; H04W 4/14

(52) U.S. Cl. CPC G06Q 20/322; G06Q 20/18; G06Q 20/325; H04W 4/14; H04W 4/008; G06Q 20/10

(57) ABSTRACT

Methods for sending information to a mobile payment device, including selecting information to be associated with a particular mobile payment device identifier, receiving an identifier stored in the mobile payment device, determining whether the received identifier corresponds to the particular mobile payment device identifier associated with the information, and transmitting the information to the mobile payment device upon determining the received identifier corresponds to the particular mobile payment device identifier associated with the information.

### CROSS-REFERENCE TO RELATED APPLICATIONS

This application claims the benefit of U.S. Provisional Application No. 61/976,575 entitled “Systems and Methods for Sending Information to Mobile Devices Utilizing Mobile Device Identifiers” filed on Apr. 8, 2014, the contents of which are incorporated by reference in their entirety herein.

### FIELD OF THE INVENTION

The invention relates to wireless communication in vending systems.

### BACKGROUND OF THE INVENTION

The development of wireless technology has led to software applications for use in mobile payment systems. These mobile payment systems may be configured for use with external components, such as point of sale systems and vending systems. There is a need for systems and methods to send information to such mobile payment systems.

### SUMMARY OF THE INVENTION

Aspects of the invention include methods for sending information to a mobile payment device. The methods include selecting information to be associated with a particular mobile payment device identifier, receiving an identifier stored in the mobile payment device, determining whether the received identifier corresponds to the particular mobile payment device identifier associated with the information, and transmitting the information to the mobile payment device upon determining the received identifier corresponds to the particular mobile payment device identifier associated with the information.

Further aspects of the invention include systems for sending information. The systems include a mobile payment device with a mobile payment application. The mobile payment application can include an identifier storage module configured to store an identifier of the mobile payment device. The systems also include a central server with a customer application interface. The customer application interface has a selection module configured to receive a selection of information to be associated with a particular mobile payment device identifier. The systems include a determination module configured to receive the identifier stored in the identifier storage module of the mobile payment device, and determine whether the received identifier corresponds to the particular mobile payment device identifier associated with the information. The systems further include a transmitter configured to transmit the information to the mobile payment device upon determining the received identifier corresponds to the particular mobile payment device identifier.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. Included in the drawings are the following figures:

FIG. 1 is a functional block diagram of a system for sending information in accordance with aspects of the invention;

FIG. 2 is a function block diagram depicting data flow within a system for sending information in accordance with aspects of the invention; and

FIG. 3 is a flowchart of steps in a method for sending information according to aspects of the invention.

### DETAILED DESCRIPTION OF THE INVENTION

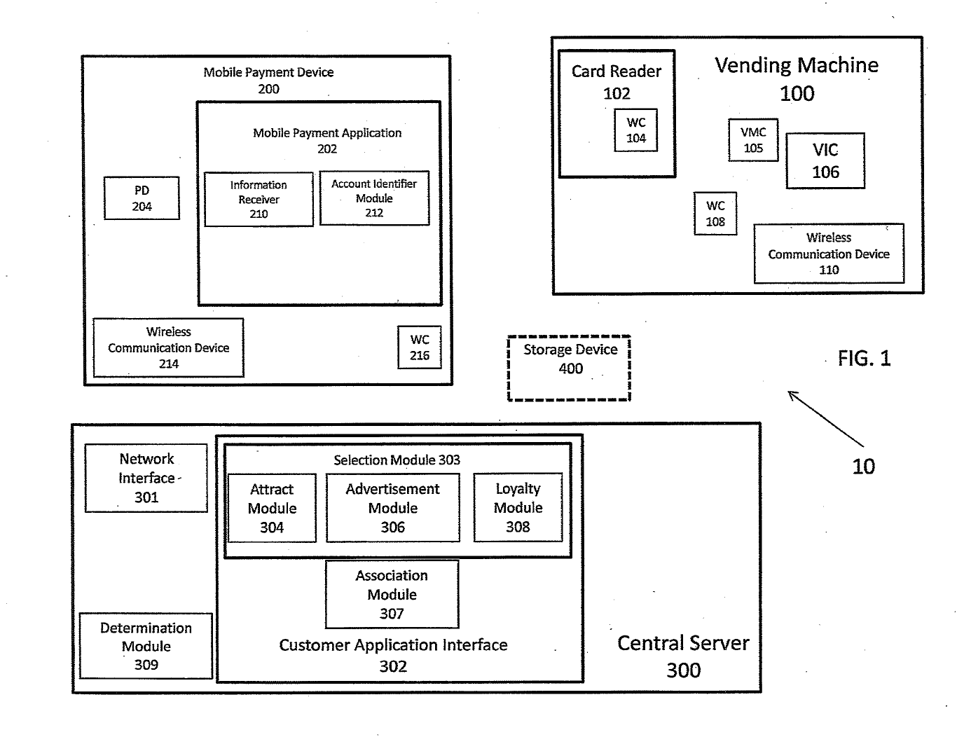

Referring to FIG. 1, a functional diagram of a system 10 according to aspects of the invention is shown. The illustrated system 10 includes a vending machine 100, a mobile payment device 200, a central server 300, and a storage device 400. Although not depicted in FIG. 1, the vending machine 100, the mobile payment device 200, the central server 300, and the storage device 400 are configured to be in communication either directly or indirectly. These components may be in communication via a wired network, Wi-Fi Internet, RF communication, near-field communication, Bluetooth communication, cellular communication, or any combination thereof. One of skill in the art will recognize other suitable communication formats for the components of system 10 from the description herein.

The vending machine 100 includes a card reader 102, a wireless communication (WC) device 104 (e.g., Bluetooth, cellular, Wi-Fi, NFC, local, etc.) coupled to the card reader 102 (or other components of the vending machine 100), a vending controller (VIC) 106, a wireless communication device 110 (e.g., cellular), and an optional wireless communication (WC) device 108 (e.g., Bluetooth, cellular, Wi-Fi, NFC, local, etc.) coupled to the VIC 106 and/or the wireless communication device 110. The card reader 102 may be a credit card reader, debit card reader, gift card reader, and/or other payment card reader suitable for tendering payment to the vending machine 100. The WC 104 and/or the WC 108 may include conventional Bluetooth communications chips in embodiments where the WC 104 and/or WC 108 are configured for Bluetooth wireless communication. The wireless communication device 110 is configured to receive and transmit information wirelessly with the other components of system 10 (e.g., mobile payment device 200, central server 300, storage device 400, etc.). The wireless communication device 110 may be configured to communicate wirelessly via Wi-Fi Internet, Bluetooth, NFC, RF, local, etc. Other suitable wireless communication formats for the wireless communication device 110 will be understood by one of skill in the art from the description herein.

The vending controller 106 enables cashless transactions (e.g., credit/debit card payments). In an embodiment, the vending controller 106 communicates with the vending machine controller (VMC) 105 of the vending machine 100. The vending controller may be a slave to the VMC 105 and may communicate with the VMC over a multi-drop bus (MDB) within the vending machine 100.

The mobile payment device 200 includes a mobile payment application 202, a presentation device 204, a wireless communication device 214, and a local communication device 216 (e.g., Bluetooth). The mobile payment device 200 may be essentially any device capable of running the mobile payment application 202 and processing mobile payments. In one embodiment, the mobile payment device 200 is a cellular telephone. The mobile payment device 200 may also be a tablet computer, a laptop or other computer, a portable electronic device, etc.

The presentation device 204 is configured to communicate information to a user of the mobile payment device 200. In one embodiment, the presentation device 204 is a visual display (e.g., LED display, LCD display, OLED display, touch screen display, etc.) capable of visually displaying text messages, video messages, offers and information, an interface of the mobile application 202, etc. The presentation device 204 may also be capable of outputting audio messages. In one embodiment, the presentation device 204 is configured to alert the user of the mobile payment device 200 of information received with visual alerts and/or audio alerts. Conventional displays for mobile payment devices may be used as the presentation device 204 of the mobile payment device 200.

The mobile payment device 200 also includes a wireless communication device 214 that is configured for wireless communications with components of the system 10. The functionality of the wireless communication device 214 may be similar to that of wireless communication device 110 as described above.

The mobile payment device 200 includes a WC device 216 configured for wireless communication (e.g., Bluetooth, cellular, Wi-Fi, NFC, etc.) with other components of the system 10. In one embodiment, the WC 216 is configured to receive signals from the vending machine 100 via WC 108 when the mobile payment device is within the transmission range of the WC 108. The WC 216 may also be configured to receive/transmit signals from/to WC 104, central server 300, and/or storage device 400, as well as the components of the mobile payment device (e.g., mobile application 202, presentation device 204, and/or wireless communication device 214).

The mobile payment device 200 has installed on it a mobile payment application 202. The mobile payment application 202 is an application designed for wireless payment. In one embodiment, the mobile payment application 202 is configured for mobile wireless payment with vending machines, such as vending machine 100.

The mobile payment application 202 includes an information receiver 210, as well as an account identifier module 212. The information receiver 210 is configured to receive information relating to the vending machine 100 associated with identifiers stored in the account identifier module 212 of the mobile payment application 202.

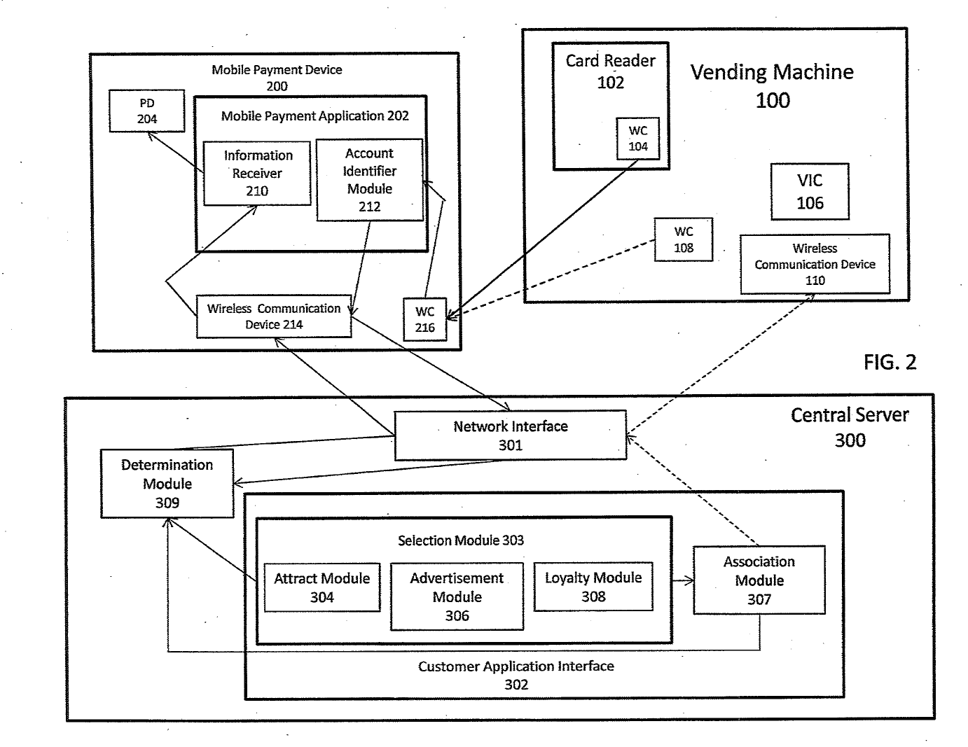

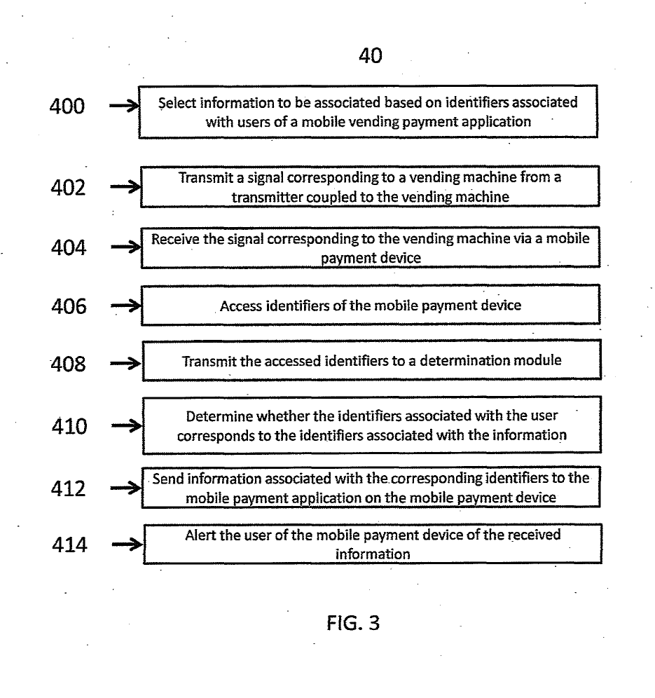

The account identifier module 212 is configured to store one or more identifiers associated with the mobile payment application 202 and/or the mobile payment device 200. Such identifiers may include the mobile service provider for the mobile payment device 200, account information for the user of the mobile payment application 202, type or brand of the mobile payment device 200, the user's payment history with the mobile payment application 202, etc. The implementation of the device identifiers stored in the account identifier module 212, as well as the implementation of the offers and information receiver 210, are described below with respect to FIGS. 2 and 3.

The central server 300 is in wireless communication with the components of the system 10 (e.g., the vending machine 100, mobile payment device 200, storage device 400, etc.). The central server 300 is configured to process information and data relating to the operation of the system 10 and configure settings for the operation of the system 10, as will be described below with respect to FIGS. 2 and 3.

The central server 300 includes a network interface 301, a customer application interface 302, and a determination module 309. The network interface 301 may be in wireless communication with the components of the system 10.

The customer application interface 302 is an interface accessible (e.g., via a website) to an operator of the mobile payment application 202 in conjunction with the vending machine 100. As used herein, the “customer” refers to the individual configuring the system 10 to operate with the vending machine 100 and the mobile payment application 202 of the mobile payment device 200, whereas the “user” of the mobile payment application 202 in the mobile payment device 200 refers to an individual utilizing the mobile payment application 202 as configured by the “customer.”

The customer application interface 302 includes a selection module 303 and an association module 307. The selection module 303 receives selections from the customer that associates information with a particular mobile payment device identifier. As used herein, “information” refers to any type of information that can be transmitted to a user of the mobile payment application 202 relating to products or services available for purchase with the mobile payment application 202, relating to account information of the user of the mobile payment application 202, and/or relating to vending machine information, such as vending machine location relative to the mobile payment device 200, which may be determined using GPS devices and/or information input by the user of the mobile payment device 200. As an example, the information may include offers (e.g., two for the price of one, etc.), discounts on items available for purchase in the vending machine 100, rewards for purchasing items from a particular vending machine, etc. As another example, the information may include location information of the vending machine 100, account balance information of the user, etc.

In accordance with aspects of the invention, the selection module 303 enables selection of a particular mobile payment device identifier by a customer to be associated with the information. For example, the customer may associate an item discount offer to a particular identifier that identifies the mobile payment device to have a particular mobile service provider. Also, the customer may associate location information of the vending machine 100 with a particular identifier that identifies the account of the user of the mobile payment application 202 being unused for a particular amount of time (e.g., an account having not been used for a week, etc.). In an embodiment, the customer may associate a promotion with a consumer's mobile payment application account.

The illustrated selection module 303 includes an attract module 304, an advertisement module 306, and a loyalty module 308. In one embodiment, the attract module 304 receives a selection of information designed to attract a user of the mobile payment application 202 to a particular vending machine 100 (e.g., location information of the vending machine 100, discounts for accounts unused for particular amounts of time, etc.). The advertisement module 306 may receive a selection of information designed to advertise a particular product in the vending machine 100. While both an attract module 304 and an advertisement module 306 are shown, it is contemplated that a single module can perform the function of both the attract module 304 and the advertisement module 306, as the information selectable by these modules may be similar. The loyalty module 308 receives selections of information designed to communicate to the user of the mobile payment application 202 of particular rewards associated with the vending machine 100 and/or products in the vending machine 100. In one embodiment, the loyalty module 308 receives a selection of information to be associated with a particular identifier that identifies the user of the mobile payment application 202 as having rewards that can be redeemed for products in the vending machine 100. The selection module 303 may include additional modules based on the type of information being selected. Other suitable modules for receiving selections from a customer of information will be understood by one of skill in the art from the description herein.

The customer application interface 302 additionally includes an association module 307. The association module 307 is configured to receive a selection of a vending machine (e.g., vending machine 100) to be associated with the information selected at the selection module 303. For example, a customer may operate multiple vending machines and, with the association module 307, the customer selects to which of the multiple vending machines the information applies. The customer may associate a first vending machine with first selected information and may associate a second vending machine with second selected information. This enables the customer to, for example, drive potential purchased to new vending machines, e.g., by providing special offers.

With the customer application interface 302, a customer may select multiple information to be associated with multiple particular mobile payment device identifiers, and may associate each selected information with a plurality of vending machines.

The central server 300 also includes a determination module 309. The determination module 309 stores the information associated with the particular mobile payment device identifier(s) selected with the selection module 303. The determination module 309 is further configured to receive, from the mobile payment application 202 of the mobile payment device 200, device identifiers stored in the account identifier module 212. In one embodiment, the determination module 309 is configured to receive the selection of the associated vending machine(s) selected with the association module 307. In an embodiment, the determination module 309 comparatively analyzes the device identifier(s) received from the mobile payment device 200 with the particular mobile payment device identifier(s) selected to be associated with the information to determine whether any of the received identifiers corresponds to any of the particular identifiers. When the determination module 309 determines a correspondence between the received identifier and the particular identifier, the determination module 309 transmits the information associated with the matched particular identifier to the information receiver 210 of the mobile payment application 202 in the mobile payment device 200. Additionally, the determination module 309 may determine whether the vending machine is selected to be associated with the information selected to be associated with the corresponding identifiers, such that the determination module 309 selectively transmits the information based on the vending machine association as well as the corresponding identifiers. If multiple matches are determined, each of the information associated with the corresponding particular identifiers may be transmitted to the information receiver 210.

The device identifier may also be an identifier associated with an account balance of the user of the mobile payment application 202. Such an identifier may indicate the remaining account balance for the user of the mobile payment application 202. In an embodiment, the information selected is an option to add funds to the user's account, and the particular mobile payment device identifier is an identifier indicating a low or empty user account balance. The determination module 309, upon determining a correspondence of the low or empty account balance identifiers, may be configured to send the option to add funds as the information. In an embodiment, when the user is alerted to this option, the user, via the mobile payment application 202, can choose to add funds to the account balance. The user may also configured the mobile payment application 202 to automatically add funds to the account balance when such information is received from the determination module 309.

In an alternative embodiment, the determination module 309 resides on the mobile payment device 200 instead of the central server 300. In such embodiments, the information and association selections made by the customer at the customer application interface 302 may be downloaded to the mobile payment application 202 of the mobile payment device 200. The determinations of corresponding identifiers, vending machine associations, and the like can be made at the mobile payment device 200, such that subsequent communication with the central server 300 may only be necessary when the information and/or association selections have changed.

In an embodiment, the customer application interface 302 supports campaigns. The campaigns may promote sales for a customer by rewarding the consumers that use the mobile payment application 202. The customer may have any number of campaigns set up for use in conjunction with the mobile payment application 202. In one embodiment, each campaign can be set up from the selection module 303 of the customer application interface 302. The campaigns may include a consumer loyalty discount (e.g., a percentage discount from an item(s) with a schedule (purchases made during predetermined time periods) and/or without a schedule), consumer cash back (e.g., a percentage of cash back when spending a predefined amount), consumer bonus cash (e.g., a percentage of additional cash when spending a predefined amount), etc. The campaigns may be communicated to the consumer via email, communication to the mobile payment application 202, communication to the mobile payment device 200, etc.

In one embodiment, the campaigns are stored on the central server 300. Each campaign may have a card associated with the campaign and linked to the campaign to be used by the consumer in establishing the consumer's account with the mobile payment application 202. The device identifiers as described above may include information associated with the campaign, card, and/or the consumer's account used with the card.

The system also includes a storage device 400. The storage device 400 may be in communication with any of the components of system 10, and is configured for information storage outside of the central server 300, the mobile payment device 200, and/or the vending machine 100. In an embodiment, the storage device 400 resides on the central server 300. In alternative embodiments, the storage device 400 may reside elsewhere, e.g., on a remote server or in the “cloud.” The storage device 400 may be configured to store selected information, associated vending machines, mobile payment device identifiers, and/or any other data used in conjunction with the system 10.

Although the system 10 is depicted to function with applications utilizing vending machines, it is contemplated that such a system can be utilized in other applications that have the ability to process payments with information with such mobile payment applications, such as mobile payment application 202. For example, retail environments, movie theaters, car dealerships, restaurants, and the like can utilize mobile payment applications with identifiers as described above. The above list is exemplary and not exclusive. Those of skill in the art will recognize from the description many additional applications other than those with vending machines that can utilize mobile payment applications with information associated with particular identifiers as disclosed herein.

Referring next to FIG. 2, a functional diagram depicting data flow within the system is shown according to aspects of the invention. The data flow depicted in FIG. 2 is exemplary, and it will be understood that alternative data flow paths and arrangements may be used to effectuate the invention from the description herein.

Referring to the central server 300, the customer utilizes the customer application interface 302 to select the information to be associated with a particular identifier and associate a vending machine with the selected information. Once the selection of the information is made, the selection, including the particular identifiers, is sent to the determination module 309 to be stored for subsequent determination. As disclosed above, the determination module 309 may optionally reside on the mobile payment device 200. The selections may also be sent to the association module 307, such that the customer can associate a particular vending machine with the selected information. In an embodiment, the selected vending machine association is sent to the determination module 309 (residing either in the central server 300 or the mobile payment device 200) to be used in subsequent determinations as to whether the selected information is to be sent/presented to the user of the mobile payment application 202. The association of the vending machines may be sent to the network interface 301 of the central server 300 and then transmitted to the wireless communication device 110 of the vending machine 100, such that the vending machine can store and transmit the associated information.

In one embodiment, the vending machine 100 continuously transmits an identification signal via the WC 104 (or alternatively, the WC 108). The identification signal may correspond to the information in embodiments where the vending machine is associated with selected information. In other embodiments, the vending machine 100 may not be associated with any information, but may continuously transmit the identification signal corresponding to the vending machine 100 (e.g., a vending machine identification number). In such embodiments, information can still apply to the vending machine 100, but particular information is not specifically associated with the vending machine 100 (e.g., the information may be based on loyalty rewards points that can be redeemed with any vending machine configured for use with the mobile payment application 202). In an embodiment, the signal transmitted from the WC 104 acts as a beacon to be received by mobile payment devices (such as mobile payment device 200) that have the mobile payment application 202 configured for mobile payment with the vending machine 100.

When a mobile payment device 200 with the mobile payment application 202 is within range of the identification signal transmitted from the WC 104, the signal is received via the WC 216 of the mobile payment device 200. The signal received at the WC 216 is sent to the account identifier module 212 of the mobile payment application 202. The account identifier module 212 includes the device identifiers of the mobile payment device 200 and/or the mobile payment application 202 (e.g., service provider, account information, loyalty information, etc.).

Once the account identifier module 212 receives the signal from the WC 216, the mobile payment application 202 may transmit the stored device identifiers via the wireless communication device 214 to the central server 300. The central server 300 receives the stored identifiers of the mobile payment device 200 via the network interface 301 and sends the received identifiers to the determination module 309. Alternatively, in embodiments where the determination module 309 resides on the mobile payment device 200, the stored device identifiers are sent to the determination module 309 within the mobile payment device 200. The determination module 309 comparatively analyzes the received identifiers with the particular identifiers associated with the selected information, along with the vending machine associations, to determine whether there is a correspondence between a particular identifier and the received identifiers.

In the event that the determination module 309 determines a correspondence between the particular identifier and one of the received identifiers, the determination module 309 transmits the information associated with the matched identifier to the information receiver 210 of the mobile payment application 202 either via the network interface 301 and the wireless communication device 214 (if the determination module 309 resides on the central server) or internally within the mobile payment device 200 (if the determination module 309 resides on the mobile payment device 200). The information receiver 210 sends the received information to the PD 204 of the mobile payment device 200 to visually alert the user of the mobile payment device 200 of the received information. The information receiver 210 may also be configured to provide an audio alert to the user of the mobile payment device 200 of the received information.

FIG. 3 is a flowchart 40 of exemplary steps for transmitting information to mobile payment devices according to aspects of the invention. At block 400, information is selected to be associated with particular mobile payment device identifiers. The information may be selected via a customer application interface 302. The information and particular identifiers may be similar to those described above. Once selected, the information to be associated with the particular identifiers may be sent to a determination module for storage and for subsequent comparison.

At block 402, a signal corresponding to a vending machine is transmitted. The signal may be transmitted via a wireless communication device, such as WC 104 and/or WC 108. The vending machine may be optionally associated with the information selected at block 400 via the customer application interface 302. In an embodiment, the vending machine is not associated with the selected information and is configured to continuously transmit the signal corresponding to the vending machine irrespective of any association.

At block 404, the signal transmitted from the vending machine is received with a mobile payment device. The signal may be received by a local wireless communication device in the mobile payment device, such as WC 216.

At block 406, identifiers of the mobile payment device are accessed via the mobile payment application in response to receiving the signal transmitted from the vending machine. The identifiers may be stored in a account identifier module (such as module 212) of the mobile payment application. The identifiers can include device, application, and user identifiers such as those described above.

At block 408, the accessed device identifiers are transmitted to a determination module residing either in the central server or on the mobile payment device. The identifiers may be transmitted via wireless communication devices in the mobile payment device and/or central server. In an embodiment, the device identifiers are stored in a storage device (e.g., storage device 212), and the identifiers are transmitted to the determination module from the storage device in response to the mobile payment device receiving a signal from the vending machine.

At block 410, the determination module determines whether the device identifiers correspond to the particular identifiers associated with selected information. The determination module may be configured to determine multiple correspondences between multiple device identifiers and multiple particular identifiers.

At block 412, the determination module sends the information associated with the corresponding identifiers to the mobile payment application of the mobile payment device. The determination module may be configured to send the information to an information receiver of the mobile payment application. In embodiments where the determination module determines multiple corresponding identifiers, the determination module is configured to send all information associated with the corresponding identifiers to the mobile payment application. The determination module may also be configured to prioritize information in the event of multiple correspondences, such that only the information that meet a priority threshold are sent to the mobile payment application of the mobile payment device.

At block 414, the user of the mobile payment device is alerted to the received offers and information. The user may be alerted via a presentation device of the mobile payment device. In an embodiment, the user is alerted with a text message. The user may also be alerted with an audio alert from the mobile payment device. Other suitable alerts with mobile payment devices will be understood by one of skill in the art from the description herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for sending information to a mobile payment device, comprising the steps of:
selecting, with an interface, information to be associated with a particular mobile payment device identifier;
receiving, from the mobile payment device, an identifier stored in the mobile payment device;
determining, with a processor, whether the received identifier corresponds to the particular mobile payment device identifier associated with the information; and
transmitting the information to the mobile payment device upon determining the received identifier corresponds to the particular mobile payment device identifier associated with the information.

2. The method of claim 1, wherein the selecting step further comprises:
associating, with the interface, the selected information with a vending machine.

3. The method of claim 2, further comprising the steps of:
transmitting, with a transmitter coupled to the vending machine, a signal corresponding to the vending machine associated with the selected information.

4. The method of claim 3, further comprising the steps of:
receiving, with a receiver of the mobile payment device, the transmitted signal corresponding to the vending machine; and
transmitting an identifier stored in the mobile payment device based on the received signal corresponding to the vending machine to a determination module.

5. The method of claim 1, wherein the information comprises at least one of an attraction message, an advertisement message, or a loyalty message.

6. The method of claim 1, wherein the identifier stored in the mobile payment device identifies at least one of a mobile service provider for the mobile payment device, a mobile payment application, or a mobile payment account.

7. The method of claim 1, further comprising the step of alerting, with the mobile payment device, a user of the mobile payment device of the transmitted information.

8. The method of claim 7, wherein the alerting step comprises displaying the transmitted information on a presentation device of the mobile payment device.

9. The method of claim 1, wherein the at least one offer is transmitted to the mobile payment device as a text message.

10. A system for sending information, comprising:
a mobile payment device including a mobile payment application with an identifier storage module configured to store an identifier of the mobile payment device;
a central server including a customer application interface that includes a selection module configured to receive a selection of information to be associated with a particular mobile payment device identifier;
a determination module configured to receive the identifier stored in the identifier storage module of the mobile payment device, and determine, with a processor, whether the received identifier corresponds to the particular mobile payment device identifier associated with the information; and
a transmitter configured to transmit the information to the mobile payment device upon determining, with the determination module, the received identifier corresponds to the particular mobile payment device identifier.

11. The system of claim 10, wherein the selection module comprises at least one of an attract module, an advertisement module, or a loyalty module.

12. The system of claim 10, further comprising a vending machine including a Bluetooth communication device configured to transmit a signal corresponding to the vending machine.

13. The system of claim 12, wherein the customer application interface further comprises an association module configured to associate the selected information with the vending machine.

14. The system of claim 12, wherein the mobile payment device further comprises a Bluetooth communication receiver configured to receive the signal transmitted from the Bluetooth communication device of the vending machine.

15. The system of claim 10, wherein the mobile payment device further comprises a presentation device configured to display the transmitted information to a user of the mobile payment device.

16. The system of claim 10, wherein the determination module resides on the central server.

17. The system of claim 10, wherein the determination module resides on the mobile payment device.
